(19) United States
(12) Patent Application Publication
(10) Pub. No.: US 2011/0149548 A1
(43) Pub. Date: Jun. 23, 2011

(54) LIGHT EMITTING DIODE BASED LINEAR LAMPS

(75) Inventors: Haitao Yang, San Jose, CA (US); Yi-Qun Li, Danville, CA (US)

(73) Assignee: INTEMATIX CORPORATION, Fremont, CA (US)

(21) Appl. No.: 12/966,890

(22) Filed: Dec. 13, 2010

Related U.S. Application Data
(60) Provisional application No. 61/289,219, filed on Dec. 22, 2009.

(51) Int. Cl. F21V 9/16; F21V 5/00

(52) U.S. Cl. 362/84; 362/217.02; 362/217.1

(57) ABSTRACT

A linear lamp (lighting bar) comprises: a linear array of LEDs and an elongate lens disposed over the array of LEDs. The lens comprises a generally concave central portion (divergent) and generally convex edge portions (convergent) and is configured such that in operation a variation in illuminance is less than 10% over an angular range of at least 90°. In one arrangement the concave central portion comprises an inner generally concave surface that faces the LEDs and an outer substantially planar and/or generally concave surface overlying the LEDs. The convex edge portions can comprise an outer generally convex surface. The lamp is suited for use in a light box for light emitting signage, under-cabinet/under-shelf lighting, cove lighting, retail display lighting, advertisement display lighting, wall sconce lighting and outdoor or indoor area lighting

### CROSS REFERENCE TO RELATED APPLICATION

This application claims the benefit of priority to U.S. Provisional Patent Application No. 61/289,219, filed Dec. 22, 2009, entitled LIGHT EMITTING DIODE BASED LINEAR LAMP by Haitao Yang et al., the specification and drawings of which are incorporated herein by reference.

### BACKGROUND OF THE INVENTION

1. Field of the Invention

This invention relates to Light Emitting Diode (LED) based linear lamps or lighting bars. Moreover, the invention concerns an LED-based linear lamp for use in a backlight or light box of a backlit sign.

2. Description of the Related Art

White light emitting LEDs (“white LEDs”) are known in the art and are a relatively recent innovation. It was not until high brightness LEDs emitting in the blue/ultraviolet (U.V.) part of the electromagnetic spectrum were developed that it became practical to develop white light sources based on LEDs. As taught, for example in U.S. Pat. No. 5,998,925, white LEDs include one or more down converting (i.e. converts photons to a lower energy level) phosphor materials, that is photo-luminescent materials, which absorb a portion of the radiation emitted by the LED and re-emit radiation of a different color (wavelength). Typically, the LED chip generates blue light and the phosphor material(s) absorbs a proportion of the blue light and re-emits light of a different color, typically yellow or a combination of green and yellow light. The portion of the blue light generated by the LED that is not absorbed by the phosphor material combined with the light emitted by the phosphor material provides light which appears to the eye as being nearly white in color.

Due to their long operating life expectancy (of order 30-50,000 hours) and high luminous efficacy (70 lumens per watt and higher) high brightness white LEDs are increasingly being used to replace conventional fluorescent, compact fluorescent and incandescent light sources. Today, most lighting fixture designs utilizing white LEDs comprise systems in which a white LED (more typically an array of white LEDs) replaces the conventional light source component. Moreover, due to their compact size, compared with conventional light sources, white LEDs offer the potential to construct novel and compact lighting fixtures.

An example of an LED-based lighting bar 10 is shown in FIG. 1. The lighting bar can be used to replace a conventional incandescent or fluorescent strip light as are commonly used in a light box of a light emitting sign. The lighting bar 10 comprises a plurality of white LEDs 12 that are mounted on an MCPCB (Metal Core Printed Circuit Board) 14 and configured as a linear array. A plurality of lenses 16 is mounted to the MCPCB 16 such that each lens 16 overlays a respective LED 12. Each lens 16 can comprise a convex lens such as a hemispherical shell and is configured to focus light emission from an associated LED. A problem with existing lighting bars is achieving a uniform illuminance.

### SUMMARY OF THE INVENTION

The present invention arose in an endeavor to provide a high lumen (typically at least 500 lm) LED-based linear lamp (lighting bar) that produces a substantially uniform illuminance over a selected range of emission angles.

According to the invention a lamp comprises: a plurality of LEDs configured as a linear array and an elongate lens disposed over the array of LEDs, the lens comprising a generally concave central portion and generally convex edge portions wherein the lens is configured such that in operation a variation in illuminance is less than 10% over a selected angular range. In this patent specification “linear” means resembling a line whose width is much narrower in proportion to its length, i.e. bar-shaped or elongate in form. Typically, though not necessarily, the LEDs are configured along a straight line in substantially one dimension. The concave central portion of the lens behaves as a divergent lens while the convex edge portions behave as a convergent lens. As is known LEDs have an angular emission characteristic in which a majority of light is emitted on axis and the light intensity drops (typically as a cosine function) with increasing angle off-axis. The central lens portion being divergent re-distributes (re-directs) a proportion of the light emitted at angles closer to the principle axis away from the axis whilst the outer convergent edge portions re-distribute light emitted at angles above a selected angle (typically about 45°) back towards the emission axis. The result of this re-distribution of emitted light results in an illuminance that is substantially uniform along the length of the lamp over a selected angular range (typically about 90°).

In one arrangement the concave central portion comprises an inner generally concave surface that faces the LEDs and an outer substantially planar and/or generally concave surface overlying the LEDs. The concave surfaces can comprise a part of a circular cylindrical surface, a part of an elliptical cylindrical surface or a multifaceted surface. Preferably the planar surface is parallel to a plane at which the LEDs are positioned and includes the concave surface overlying the LEDs.

Advantageously the convex edge portions of the lens comprise an outer generally convex surface that comprises a part of a circular cylindrical surface, a part of an elliptical cylindrical surface or a multifaceted surface.

The concave surface facing the LEDs can further comprise at least two substantially planar surface portions. Preferably the planar surface portions are oriented at an angle in a range of about 20° to 45° to the plane at which the LEDs are located. In a preferred implementation the planar surface portions are oriented at an angle of about 30°.

Where the lamp is intended for general lighting the LEDs are preferably operable to emit light that appears white in color. Preferably the lamp is configured in operation to emit a luminous flux of at least 500 lumens.

The lens can comprise a polycarbonate, an acrylic or other light transmissive material such as glass.

In accordance with a further aspect of the invention an LED lamp comprises: a plurality of LEDs configured as a linear array and an elongate lens disposed over the array of LEDs, wherein the lens has a cross-section comprising an inner generally concave surface that faces the LEDs and an outer generally convex surface including a planar and/or concave surface overlying the LEDs. The lens is configured such that in operation the angular variation of illuminance is less than 10% over an angular range of about 90°. The planar surface and/or concave surface overlying the LEDs in conjunction with the inner concave surface define a central portion that is generally divergent and edge portions that are convergent.

In one arrangement the convex surface, the concave surface facing the LEDs and the concave surface overlying the LEDs is a part of a circular cylindrical surface. In other arrangements one or more of the surfaces can comprise a part of an elliptical cylindrical surface, other curved surfaces or a multifaceted surface.

Preferably the planar surface is parallel to a plane at which the LEDs are positioned and includes the concave surface overlying the LEDs.

The inner concave surface facing the LEDs can further comprise at least two substantially planar surface portions. Preferably the planar surfaces are oriented at an angle in a range of about 20° to 45° to the plane on at which the LEDs are located and more preferably at an angle of about 30°.

Lamps in accordance with the invention find particular application, but are not limited to, a backlight or light box for a light emitting sign. The lamps further find application in under-cabinet lighting, under-shelf lighting, cove lighting, retail display lighting, advertisement display lighting, wall sconce lighting or lighting applications requiring a uniform illumination.

According to a yet further aspect of the invention a light box comprises: a housing having an opening that comprises a light emitting plane of the light box and at least one lamp in accordance with the invention. Depending on the surface area of the light emitting plane the light box can comprise a plurality of lamps that are configured such that a variation in illuminance over the light emitting plane is less than 10%.

According to a still yet further aspect of the invention a light emitting sign comprises a light box in accordance with the invention and a light transmissive display surface positioned at the light emitting plane. In one configuration the light box is operable to emit light that appears white in color and the signage information (numerals, symbols, letters, devices, graphics, images, indicia etc) is located at the display surface and filters the white light to generate a desired color of light emission. The signage information can comprise for example printed material overlying the display surface, light transmissive color film applied to the display surface or inks/dies/pigments that are applied to the display surface by screen printing, inkjet printing etc.

The light box can be configured to generate white light by configuring the LEDs to emit white light by the inclusion of one or more phosphor materials in the LED package. Alternatively the LEDs can be configured to emit blue light having a dominant wavelength in a wavelength range 400 to 480 nm and the display surface further comprises at least one phosphor material configured in operation to absorb at least a portion of light emitted by the LEDs and to emit light of a selected color and wherein light emitted by the light box comprises the combined light from the LEDs and at least one phosphor and appears white in color. In such an arrangement the phosphor material(s) in conjunction with the blue light is used to homogeneously generate white over the entire light emitting display surface. The phosphor material(s) can be screen printed or otherwise applied to the face of the display surface to form one or more layers of uniform thickness. Alternatively the phosphor material(s) can be incorporated into the display surface such that it is uniformly distributed throughout the volume of the display surface.

In a further light emitting sign at least one phosphor material is configured to define signage information and to generate light of a selected color. An advantage of a phosphor-based sign compared with a conventional backlit sign in which the display surface filters white light generated by the backlight to generate a desired color of light, is that the display surface homogeneously generates the required color of light over the entire surface. The result is that such a sign is able to generate more vivid colors of light that are more eye-catching and resemble the light emission of neon signage. Preliminary tests indicate that a phosphor-based sign could reduce energy consumption by about 50% to 75% compared with a sign backlit with white LEDs and more than 80% compared with a sign backlit by compact fluorescent lamps. In one such sign the LEDs are configured to emit blue light having a dominant wavelength in a wavelength range 400 to 480 nm and the display surface further comprises at least one phosphor material configured to define signage information and operable to absorb at least a portion of light emitted by the LEDs and to emit light of a selected color. The phosphor material(s) can be screen printed or otherwise applied to a surface of the display surface in the form of a selected pattern to define numerals, symbols, letters, devices, graphics, images, indicia etc. Alternatively the phosphor material(s) can be incorporated into a light transmissive film that is then applied to the display surface or incorporated into the display surface.

### BRIEF DESCRIPTION OF THE DRAWINGS

In order that the present invention is better understood LED-based lamps and a light emitting sign, in accordance with the invention will now be described, by way of example only, with reference to the accompanying drawings in which:

FIG. 1 is a partially exploded schematic perspective representation of a known lighting bar as previously described;

FIG. 2 is a partially exploded schematic perspective representation of an LED lighting bar in accordance with the invention;

FIG. 3 is a sectional view of the LED lighting bar of FIG. 2 through a plane A-A;

FIG. 4 is a view showing the lens geometry of the LED lighting bar of FIG. 2;

FIGS. 5a and 5b illustrate the principle of operation of the lens of FIG. 4;

FIG. 6 is a plot of intensity versus angle for an LED lighting bar in accordance with the invention;

FIG. 7 is a plot of illuminance versus horizontal offset d for an LED lighting bar in accordance with the invention;

FIG. 8 is a schematic sectional view of part of a light emitting sign incorporating the lighting bars of FIG. 3;

FIG. 9 is a schematic perspective view of the light emitting sign of FIG. 8;

FIG. 10 is a plot of illuminance versus distance for the light emitting sign of FIG. 8;

FIG. 11 is a schematic perspective representation of an LED lighting bar in accordance with an embodiment of the invention; and

FIG. 12 is a sectional view of the LED lighting bar of FIG. 10 through a plane A-A.

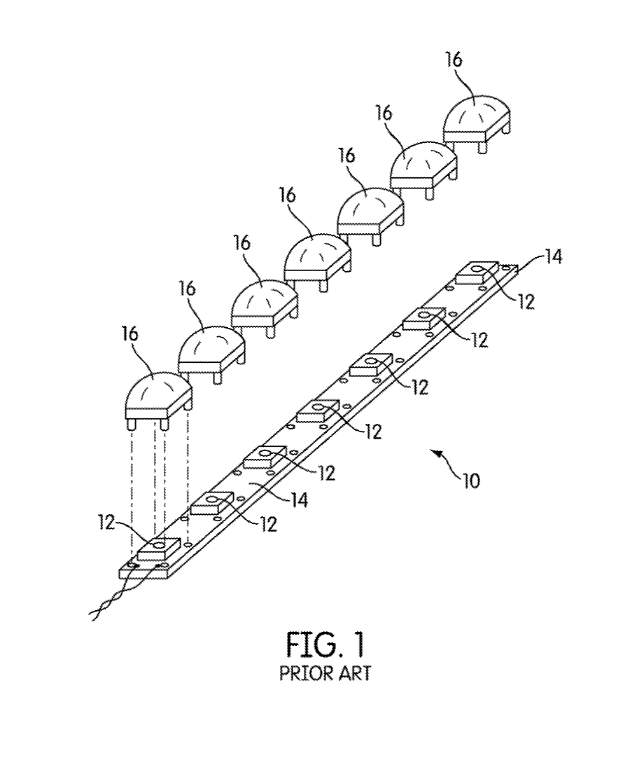

### DETAILED DESCRIPTION OF THE INVENTION

Embodiments of the invention are directed to LED-based linear lamps (linear lighting modules or LED lighting bars) comprising a linear array of LEDs and an elongate lens disposed over the LEDs that is configured to produce a generally uniform illuminance (total luminous flux incident per unit area).

Throughout this specification like reference numerals are used to denote like parts.

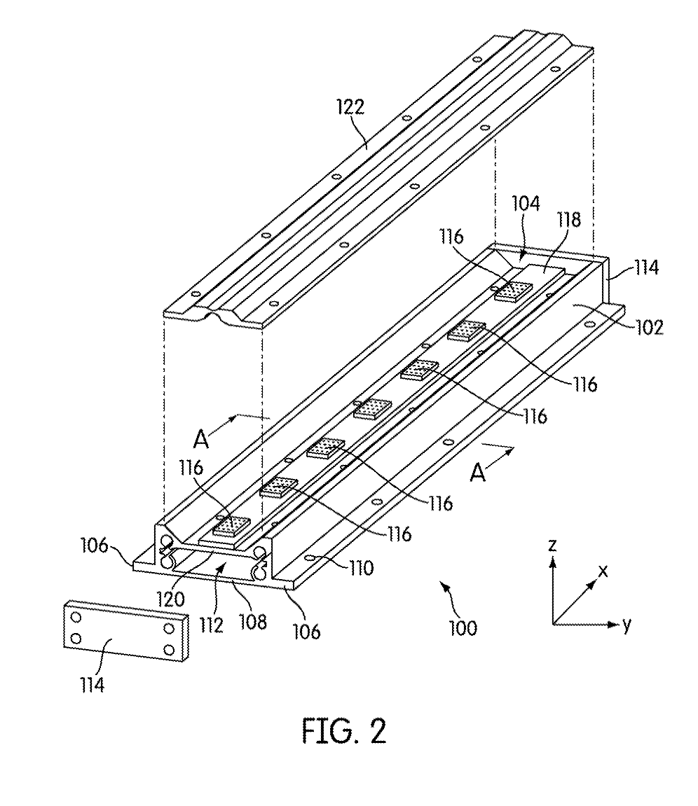

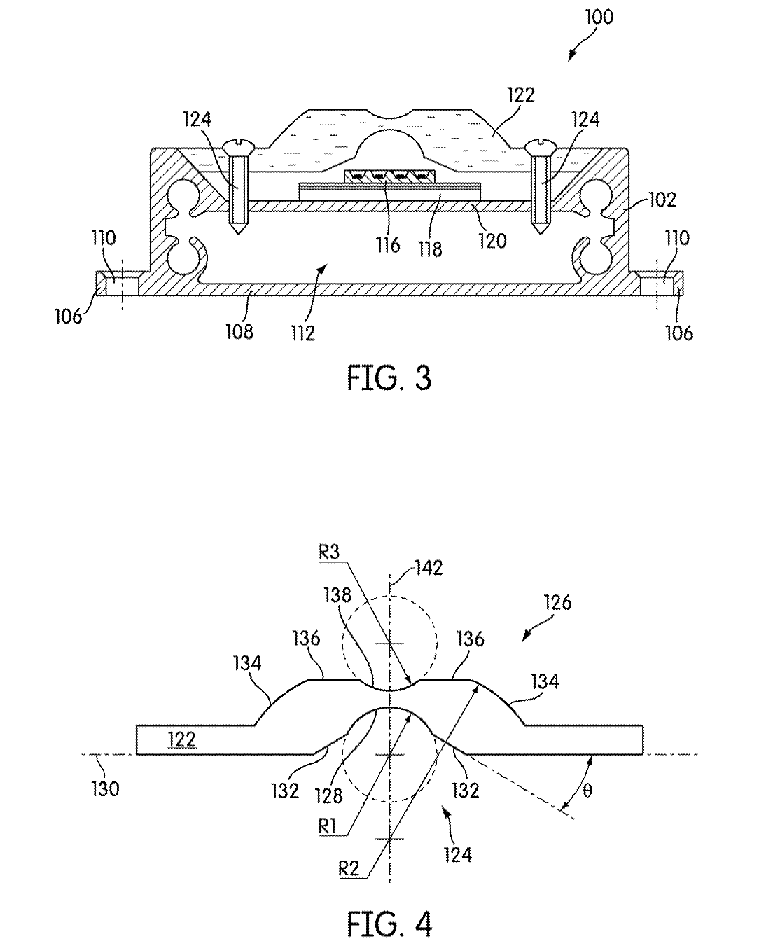

A linear lamp (lighting bar) 100 in accordance with a first embodiment of the invention is now described with reference to FIGS. 2 and 3 which respectively show a partially exploded schematic perspective representation of the LED lighting bar and a sectional view of the LED lighting bar through a plane A-A. The lighting bar 100 is configured to generate white light with a Correlated Color Temperature (CCT) of ≈2700K, 3000K, 4000K or 6500K and an emission luminous flux of ≈560 lm (2700K, 3000K) or ≈600 lm (4000K, 6500K). The lighting bar 100 is intended, but not limited, to use within a light box (backlight) of a light emitting sign.

The lighting bar 100 comprises an elongate body 102 which for ease of fabrication comprises an extruded aluminum section. As shown in FIG. 2 the body 102 is hollow in form and has a generally rectangular cross-section with a shallow channel 104 in the upper surface and shoulders 106 projecting from the edges of the base 108. The walls of the channel 104 are beveled (that is inclined at an angle of about 45° to the floor of the channel) to promote emission of light from the lamp. The shoulders 106 can include through holes 110 to enable mounting of the lighting bar 100. The body 102 which is hollow defines a cavity 112 and the ends of the body can be closed by a respective rectangular plate 114.

The lighting bar 100 further comprises a plurality (nine in the example illustrated) 1 W high power white LEDs 116. Each LED 116 preferably comprises a plurality of co-packaged LED chips (dies) as for example is described in co-pending United States patent Application Publication No. 2009-0294780 filed May 27, 2008, the entire content of which is incorporated herein by way of reference thereto. In the embodiment illustrated, each LED 116 comprises a square multilayered ceramic package having a square array of sixteen (four rows by four columns) circular recesses (blind holes) that can each house a respective GaN (gallium nitride) based blue light emitting LED chip. The LEDs generate blue light having a dominant wavelength in a range 400 nm to 480 nm and typically around 460 nm. Since it is required to generate white light each recess can be potted with a phosphor (photo luminescent) material. The phosphor material, which is typically in powder form, is mixed with a transparent binder material such as a polymer material (for example a thermally or UV curable silicone or an epoxy material) and the polymer/phosphor mixture applied to the light emitting face of each LED chip.

The LEDs 116 are configured as a linear array and mounted on a strip of MCPCB (Metal Core Printed Circuit Board) 118. As is known a MCPCB comprises a layered structure composed of a metal core base, typically aluminum, a thermally conducting/electrically insulating dielectric layer and a copper circuit layer for electrically connecting electrical components in a desired circuit configuration. In this patent specification “linear” means resembling a straight line whose width is much narrower in proportion to its length, i.e. bar-shaped or elongate in form. As shown the LEDs are typically, though not necessarily, configured along a straight line in substantially one dimension. The metal core base of the MCPCB 118 is mounted in thermal communication with the floor 120 of the channel 104 with the aid of a thermally conducting compound such as for example an adhesive containing a standard heat sink compound containing beryllium oxide or aluminum nitride. Rectifier or other driver circuitry (not shown) for operating the lamp 100 directly from an AC mains power supply can be housed within the cavity 112 of the body 102.

The lighting bar 100 further comprises an elongate or bar-shaped lens 122 that is configured to cover the channel 104. As shown the lens can be fixed to the body 102 by means of screws, bolts or other fasteners 124 that engage with the floor 120 of the channel. The lens 122 preferably comprises a polycarbonate though it can comprise any light transmissive material such as an acrylic, silicone, polymer material or glass.

The geometry of the lens 122 will now be described with reference to FIG. 4 which shows the lens cross-section. The lens 122 has a uniform cross-section along its length and comprises a generally concave inner surface 124 that faces the LEDs 116 and a generally convex outer surface 126 from which light is emitted. The generally concave surface 124 comprises a part of a circular cylindrical surface 128 of radius R1 whose center is located on the emission plane 130 of the LEDs 116. The concave inner surface 124 further comprises two planar surface portions 132 that are inclined at an opposing angle θ to the emission plane 130. In the example illustrated the planar surfaces are inclined at an angle θ of about 30° though in other embodiments that can be inclined at an angle θ=20° to 45°.

The generally convex outer surface 126 comprises a part of a circular cylindrical surface 134 of radius R2 whose center is located below the emission plane 130 of the LEDs 116. As shown the upper portion of the cylindrical surface 134 (i.e. the portion distal to the LEDs) comprises a planar surface 136 that is parallel with the emission plane 130. The convex outer surface 126 further comprises a concave portion 138 extending into the planar surface 136 and overlying the concave surface 128. The concave surface 138 comprises a part of a circular cylindrical surface of radius R3 in which the example illustrated R3=R1.

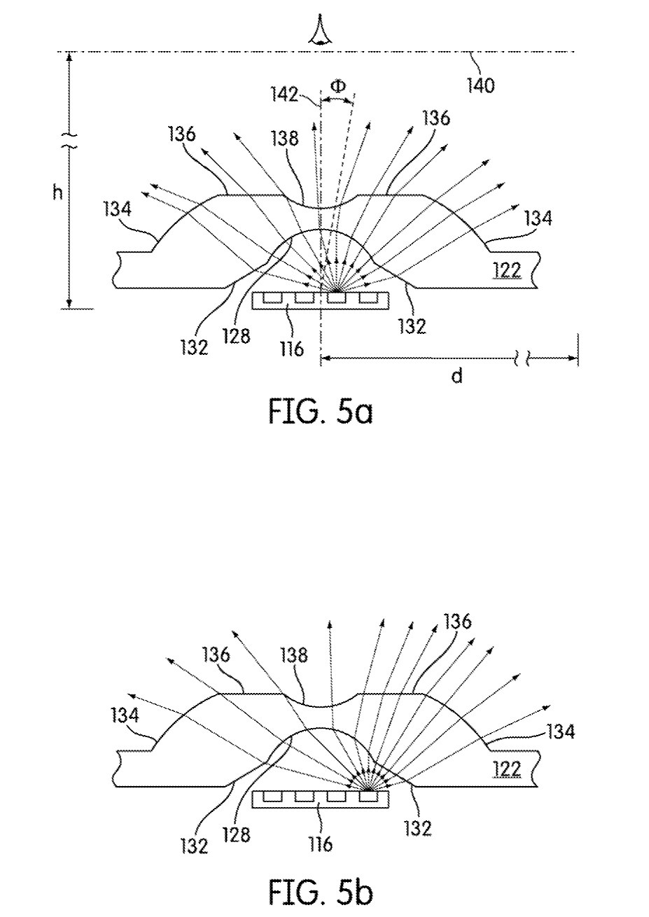

FIGS. 5a and 5b are schematic representations of the lens 122 illustrating light paths originating from LED chips located in different locations within the LED package 116. As can be seen from FIGS. 5a and 5b the central portion of the lens corresponding to the planar surface 136 and concave surface 138 behave as a divergent lens portion while the peripheral or edge portions of the lens 122 corresponding to the convex surfaces 134 behave as convergent lens portions. The lens 122 is configured to give a more uniform illumination over a desired emission angle range. As is known LEDs have an angular emission characteristic in which a majority of light is emitted on axis and the light intensity drops (typically as a cosine function) with increasing angle off-axis. The central lens portion being divergent re-distributes (re-directs) a proportion of the light emitted at angles closer to the principle axis slightly away from the axis whilst the outer convergent lens portions re-distribute light emitted at angles above a selected angle (typically about 45° to 60°) slightly back towards the emission axis. The result of this re-distribution of emitted light results in an illuminance that is substantially uniform at a plane 140 along the length of the lamp over a selected angular range. The range of angles is a consequence of the LEDs not being a point light source that is located at a central plane 142 of the lens. As a result of this re-directing of light the illumination produced by the lighting bar is substantially uniform over a selected angular range.

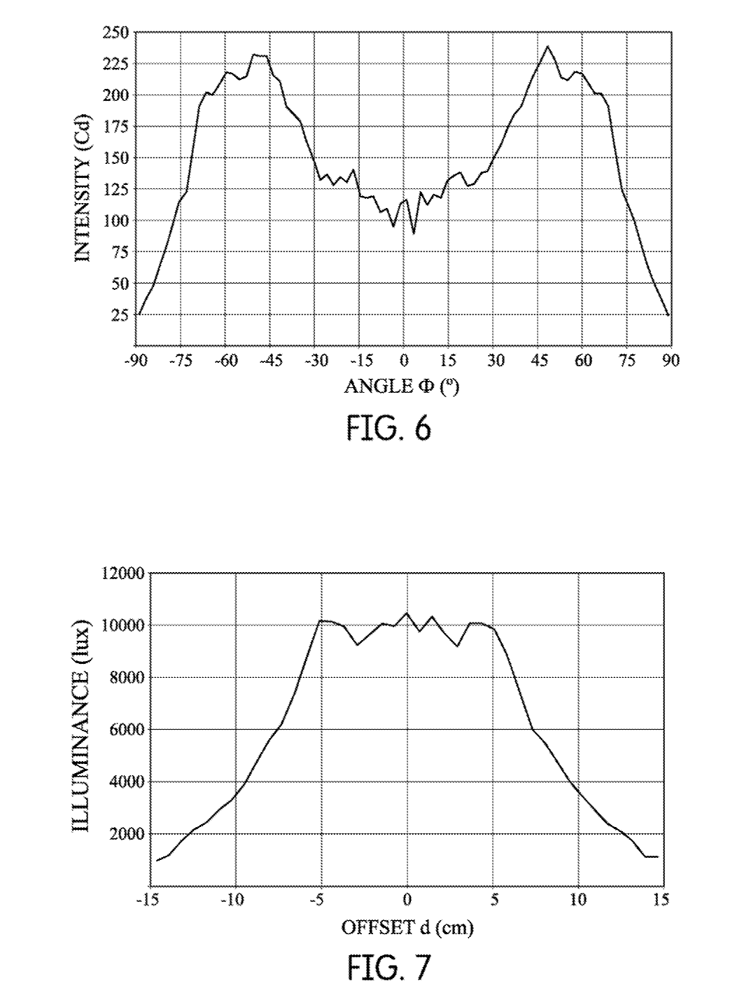

FIG. 6 is a plot of emission intensity (Cd) versus angular deviation Φ (°) and FIG. 7 is a plot of illuminance (lux) versus horizontal offset d (cm). Both plots are for measurements at a measuring plane 140 that is parallel with the emission plane 130 of the LEDs and located a distance h=5 cm (see FIG. 5a) from the emission plane 130. As shown in FIG. 5a the horizontal offset d is measured in a direction y that is perpendicular to the central plane 142 of the lens (x direction). As can be seen from FIG. 6 the lens 122 has the effect of directing a proportion of the emitted light away from the axis of the lighting bar such that the maximum emission intensity now occurs at about −45° and +45°. The result of this re-direction of light is that the illuminance is substantially uniform over a selected angular range. As can be seen from FIG. 7 the illuminance is substantially constant (variation <8%) over an range of offsets −5 cm to 5 cm corresponding to an angular variation Φ of −45° to 45°.

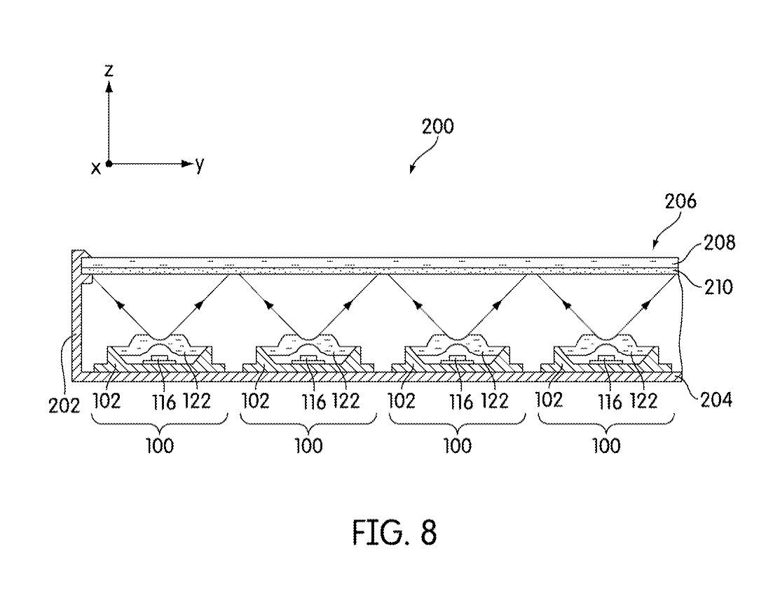

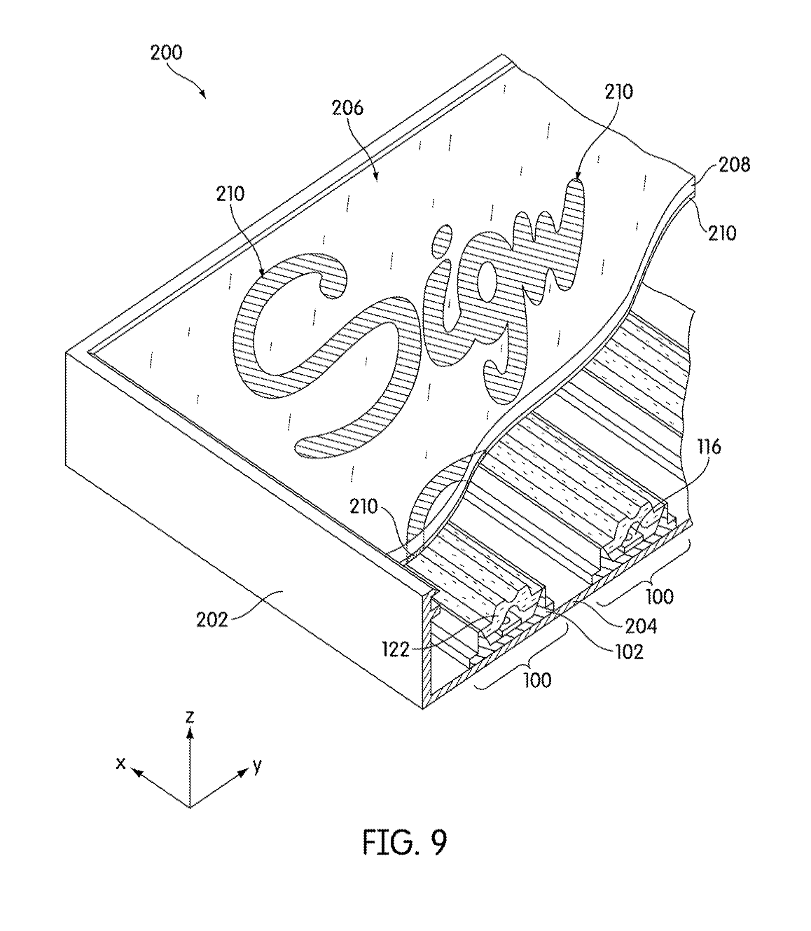

FIGS. 8 and 9 respectively show schematic sectional and schematic perspective views of a part of a backlit the light emitting sign 200 incorporating the LED lighting bars 100 of the invention. The sign 200 is intended for use in retail signage, large format advertising boards, premise name plates, channel lettering etc. The sign 200 comprises a shallow open rectangular housing 202 that houses a plurality of lighting bars 100 mounted on the floor 204 of the housing. In FIG. 8 the lighting bars 100 run into the plane of the paper in a direction x. The housing 202 can be fabricated from a material having a good thermal conductivity (typically ≧150 Wm⁻¹K⁻¹ and preferably ≧150 Wm⁻¹K⁻¹) such as sheet as aluminum to aid in the dissipation of heat generated by the lighting bars 100. In alternative embodiments the can be fabricated from a polymer material or metal loaded polymer material.

A light emitting display or signage surface 206 is provided overlying the opening of the housing 202. The display surface 206 comprises a window 208 comprising a sheet of light transmissive material 208 such as a polycarbonate or acrylic and signage information 210 on a surface of the light transmissive material 208. As shown the signage information 210 can be provided on the inner surface of the light transmissive window 208 facing the lighting bars 100. Such an arrangement the light transmissive window 208 can provide environmental protection of the signage information 210.

In a preferred embodiment and as disclosed in our co-pending United States patent application Publication No. 2007-0240346 entitled “Light emitting sign and display surface therefor” to Li et al., the specification and drawings of which is incorporated herein by reference, the signage information 210 comprises one or more phosphor, photoluminescent materials, that are screen printed or otherwise applied to the surface of the light transmissive window 208. The phosphor material(s) can be applied to the display surface in the form of a selected pattern to define numerals, symbols, letters, devices, graphics, images, indicia etc. Alternatively the phosphor material(s) can be incorporated into a light transmissive film that is then applied to the display surface or incorporated into the light transmissive window 208. In a phosphor-based light emitting sign the lighting bars 100 are configured to emit blue light (400 nm to 480 nm) and the phosphor material absorbs at least a proportion of the blue light and emits light of a different desired color. Areas of the sign that are required to be blue in color do not typically include a phosphor material. An advantage of a phosphor-based sign compared with a conventional backlit sign in which the display surface filters white light generated by the backlight to generate a desired color of light, is that the display surface homogeneously generates the required color of light over the entire surface and is more energy efficient. The result is that the sign of the invention is able to generate more vivid colors of light that are more eye-catching and resemble the light emission of neon signage. Preliminary tests indicate that a phosphor-based sign could reduce energy consumption by about 50% to 75% compared with a sign backlit with white LEDs and more than 80% compared with a sign backlit by compact fluorescent lamps. Unlike existing fluorescent paint based signage, the signs of the invention are unaffected by sunlight/U.V.

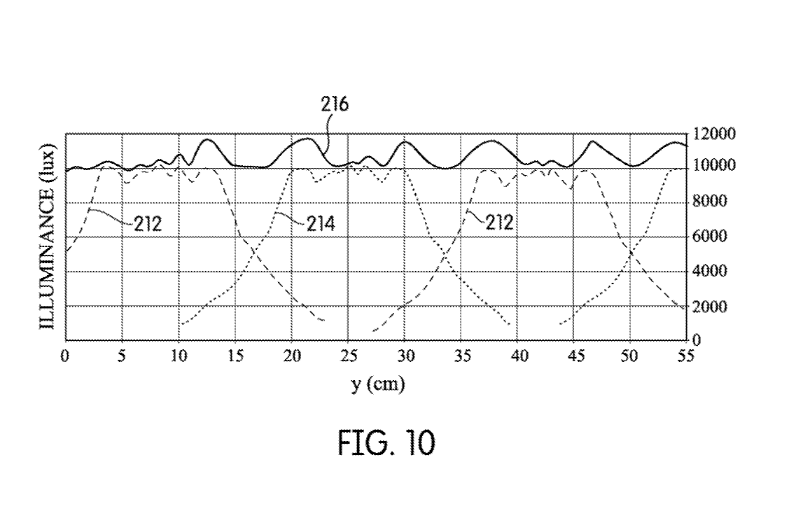

The number and spacing of the lighting bars 100 is selected such that the illuminance is substantially uniform (that is the variation is typically less than about 10%) over the entire surface area of the display surface 206. FIG. 10 is a plot of illuminance (lux) versus distance y (cm) at the display surface 206 for the light emitting sign 200. In FIG. 10 the dashed line 212 and dotted line 214 are illuminance plots for individual lighting bars 100 and the solid line 216 is a plot of the combined illuminance at the display surface 206. As can be seen from FIG. 10 by careful configuration of the lighting bars 100 a substantially uniform illuminance can be achieved across the entire display surface 206.

In alternative embodiments white light emitting lighting bars 100 can be utilized and the display surface 206 acts as a color filter to impart a desired color. In the case of channel lettering the display surface 206 can comprise a filter of a single color or a display surface having a uniform layer of phosphor material on at least one surface. In yet a further embodiment the one or more phosphor materials can be homogeneously incorporated into the light transmissive window 208.

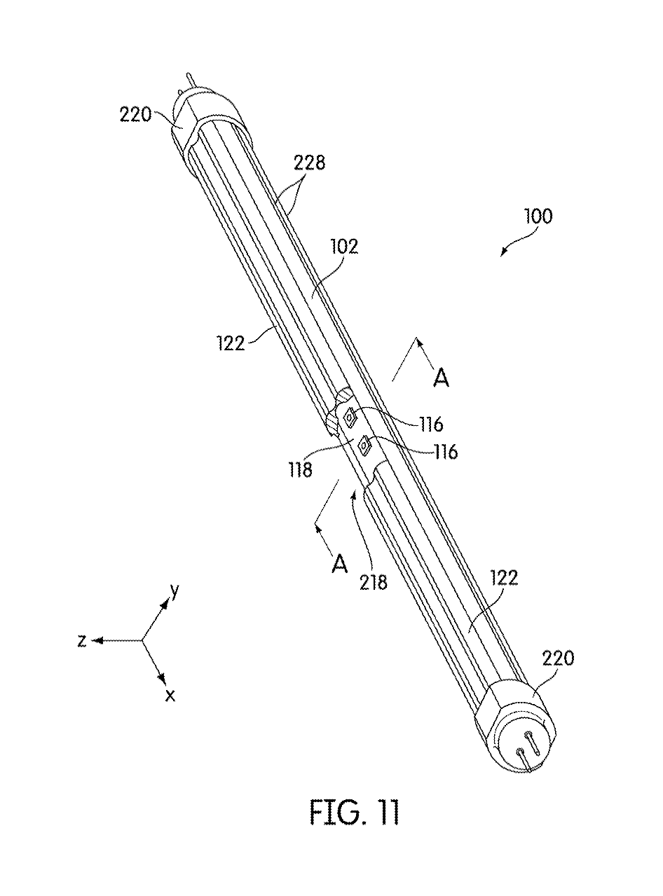

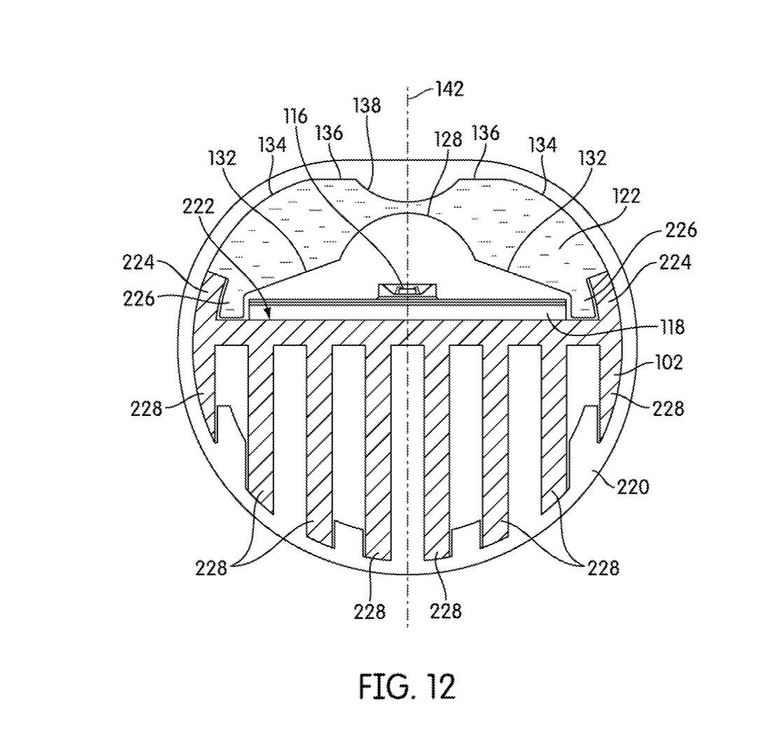

An LED linear lamp (tubular lamp) 100 in accordance with a second embodiment of the invention is now described with reference to FIGS. 11 and 12 which respectively show a schematic perspective representation and a sectional view of the tubular lamp through a plane A-A. The tubular lamp 100 is configured to be a direct replacement for a “T8” fluorescent tube lamp. As is known fluorescent tubes are classified by the nomenclature “Tn” where “T” indicates the lamp is tubular in form and “n” is the diameter of the lamp in eights of an inch (⅛″). Thus the body of a T8 tubular lamp is nominally one inch (1″) in diameter. T8 fluorescent tubes are commonly used in backlit light emitting signage and the tubular lamp of the invention is intended for such applications.

In FIG. 11 a portion 218 of the lens 122 is removed to show the linear array of LEDs 116. The lamp 100 further comprises a bi-pin connector cap 220 attached to each end of the lamp body 102. It will be appreciated that depending on the intended application the connector caps 220 can comprise other connector arrangements such as a recessed double contacts, single pin connectors, bayonet type connectors etc.

Referring to FIG. 12 the lamp body 102 comprises an extruded aluminum section that is generally semicircular in cross-section. In FIG. 12 the body is oriented with a planar surface 222 shown uppermost. An MCPCB 118 carrying the linear array of LEDs 116 is mounted in thermal communication with the planar upper surface 222 of the body 102. Running the length of the body 102 along both edges of the planar surface 222 a respective wall portion 224 extends upwardly and is inclined inwardly towards the central plane 142 of the lamp. The wall portions 224 are used to secure the lens 122 to the body by means of a complimentary shaped, generally tapered (dovetailed), cooperating portion 226 on the lens. The lens 122 can be slid into engagement with the body 102 and secured by the connector caps 220. The lower semicircular portion of the body 102 comprises a series of ribs 228 that extend in a direction orthogonal to the planar surface 222 and which run the length of the body 102. The ribs 228 increase the surface area of the body and act as heat radiating fins or veins to aid in cooling of the LEDs 116. Eight ribs are shown in the embodiment shown though it will be appreciated that the number and/or configuration can be adapted for an intended application.

Operation of the tubular lamp 100 of FIGS. 11 and 12 is the same as that of the lamp of FIGS. 2 and 3 and is not described further.

The linear lamp (lighting bar) of the invention is not restricted to the specific embodiment described and variations can be made that are within the scope of the invention. For example, whilst the invention arose in relation to lighting bar for use within a light box the lighting bar of the invention finds other applications including under-cabinet/under-shelf lighting, cove lighting, retail display lighting, wall sconces and outdoor/indoor area lighting. Moreover, it is envisaged in other embodiments to incorporate the phosphor material in the lens or provide the phosphor material in the form of one or more layers on the surface of the lens. Moreover whilst the convex and concave lens portions can be part of a circular cylindrical surface in other arrangements they can comprise part of an elliptical cylindrical surface, other curved surfaces or multifaceted surfaces.

What is claimed is:

1. A lamp comprising: a plurality of LEDs configured as a linear array and an elongate lens disposed over the array of LEDs, the lens comprising a generally concave central portion and generally convex edge portions wherein the lens is configured such that in operation a variation in illuminance is less than 10% over an angular range of at least 90°.

2. The lamp according to claim 1, wherein the concave central lens portion comprises an inner generally concave surface that faces the LEDs and an outer substantially planar and/or generally concave surface overlying the LEDs.

3. The lamp according to claim 2, wherein the concave surfaces are selected from the group consisting of being: a part of a circular cylindrical surface, a part of an elliptical cylindrical surface and a multifaceted surface.

4. The lamp according to claim 2, wherein the planar surface is parallel to a plane on which the LEDs are positioned.

5. The lamp according to claim 4, wherein the planar surface includes the concave surface overlying the LEDs.

6. The lamp according to claim 1, wherein the convex edge portions comprise an outer generally convex surface.

7. The lamp according to claim 6, wherein the outer convex surface is selected from the group consisting of being: a part of a circular cylindrical surface, a part of an elliptical cylindrical surface and a multifaceted surface.

8. The lamp according to claim 2, wherein the concave surface facing the LEDs further comprises at least two substantially planar surfaces.

9. The lamp according to claim 8, wherein the planar surfaces are oriented at an angle in a range of about 20° to 45° to the plane on which of the LEDs are located.

10. The lamp according to claim 9, wherein the planar surfaces are oriented at an angle of about 30°.

11. The lamp according to claim 1, and configured in operation to emit a luminous flux of at least 500 lumens.

12. The lamp according to claim 1, wherein the lamp is selected from the group consisting of being configured for: under-cabinet lighting, under-shelf lighting, cove lighting, retail display lighting, advertisement display lighting, wall sconce lighting, outdoor area lighting and indoor area lighting.

13. A light box comprising: a housing having an opening that comprises a light emitting plane of the light box and at least one lamp comprising: a plurality of LEDs configured as a linear array and an elongate lens disposed over the array of LEDs, the lens comprising a generally concave central portion and generally convex edge portions wherein the lens is configured such that in operation a variation in illuminance is less than 10% over an angular range of at least 90°.

14. A light emitting sign comprising the light box according to claim 13 and a light transmissive display surface positioned at the light emitting plane.

15. The sign according to claim 14, wherein the light box is operable to generate light that appears white in color.

16. The sign according to claim 15, wherein the LEDs are operable to emit light that appears white in color.

17. The sign according to claim 14, wherein the LEDs are configured to emit light having a dominant wavelength in a wavelength range 400 to 480 nm and wherein the display surface further comprises at least one phosphor material configured in operation to absorb at least a portion of light emitted by the LEDs and to emit light of a selected color and wherein light generated by the light box comprises the combined light emitted by the LEDs and at least one phosphor material and appears white in color.

18. The sign according to claim 14, wherein the LEDs are configured to emit blue light having a dominant wavelength in a wavelength range 400 to 480 nm and wherein the display surface further comprises at least one phosphor material configured to define signage information and operable to absorb at least a portion of light emitted by the LEDs and to emit light of a selected color.

19. The sign according to claim 18, wherein the at least one phosphor material is selected from the group consisting of: being provided as at least one layer on a surface of the light transmissive display surface and being incorporated in the light transmissive display surface.

20. A lamp comprising: a plurality of LEDs configured as a linear array and an elongate lens disposed over the array of LEDs, wherein the lens has a cross-section comprising an inner generally concave surface that faces the LEDs and an outer generally convex surface including a planar and/or concave surface overlying the LEDs.

21. The lamp according to claim 20, and configured such that in operation the angular variation of illuminance is less than 10% over a angular range of about 90°.

22. The lamp according to claim 20, wherein the inner concave surface facing the LEDs is selected from the group consisting of being: a part of a circular cylindrical surface, a part of an elliptical cylindrical surface and a multifaceted surface.

23. The lamp according to claim 20, wherein the outer convex surface is selected from the group consisting of being: a part of a circular cylindrical surface, a part of an elliptical cylindrical surface and a multifaceted surface.

24. The lamp according to claim 20, wherein the concave surface overlying the LEDs is selected from the group consisting of being: a part of a circular cylindrical surface, a part of an elliptical cylindrical surface and a multifaceted surface.

25. The lamp according to claim 20, wherein the planar surface is parallel to a plane at which the LEDs are positioned.

26. The lamp according to claim 25, wherein the planar surface includes the concave surface overlying the LEDs.

27. The lamp according to claim 20, wherein the inner generally concave surface that faces the LEDs further comprises planar surface portions.

28. The lamp according to claim 27, wherein the planar surface portion are oriented at an angle in a range of about 20° to 45° to the plane on which of the LEDs are located.

29. The lamp according to claim 28, wherein the planar surface portions are oriented at an angle of approximately 30°.

30. The lamp according to claim 20, wherein each of the concave surfaces and convex surface are selected from the group consisting of being: a part of a circular cylindrical surface, a part of an elliptical cylindrical surface and a multifaceted surface.

31. The lamp according to claim 20, and configured in operation to emit a luminous flux of at least 500 lumens.

32. The lamp according to claim 20, wherein the lamp is selected from the group consisting of being configured for: under-cabinet lighting, under-shelf lighting, cove lighting, retail display lighting, advertisement display lighting, wall sconce lighting, outdoor area lighting and indoor area lighting.

33. A light box comprising: a housing having an opening that comprises a light emitting plane of the light box and at least one LED lamp comprising: a plurality of LEDs configured as a linear array and an elongate lens disposed over the array of LEDs, wherein the lens has a cross-section comprising an inner generally concave surface that faces the LEDs and an outer generally convex surface including a planar and/or concave surface overlying the LEDs.

34. A light emitting sign comprising the light box according to claim 33 and a light transmissive display surface positioned at the light emitting plane.

35. The sign according to claim 34, wherein the light box is operable to generate light that appears white in color.

36. The sign according to claim 35, wherein the LEDs are operable to emit light that appears white in color.

37. The sign according to claim 34, wherein the LEDs are configured to emit light having a dominant wavelength in a wavelength range 400 to 480 nm and wherein the display surface further comprises at least one phosphor material configured in operation to absorb at least a portion of light emitted by the LEDs and to emit light of a selected color and wherein light generated by the light box comprises the combined light emitted by the LEDs and at least one phosphor material and appears white in color.

38. The sign according to claim 37, wherein the at least one phosphor material is selected from the group consisting of: being provided as at least one layer on a surface of the light transmissive display surface and being incorporated in the light transmissive display surface.
